(19) United States
(12) Patent Application Publication
(10) Pub. No.: US 2016/0089787 A1
(43) Pub. Date: Mar. 31, 2016

(54) ROBOT CONTROLLER

(71) Applicant: FANUC Corporation, Yamanashi (JP)

(72) Inventor: Teruki KUROSHITA, Yamanashi (JP)

(21) Appl. No.: 14/858,099

(22) Filed: Sep. 18, 2015

(30) Foreign Application Priority Data
Sep. 25, 2014 (JP) 2014-195420

(51) Int. Cl. B25J 9/16

(52) U.S. Cl. CPC B25J 9/1633; B25J 9/1666; Y10S 901/01; Y10S 901/46

(57) ABSTRACT

A robot controller of the present invention comprises a movement control part which controls an operation of a robot so that a movable part of the robot moves on a predetermined track, and a return control device which controls an operation of the robot so that if the movable part departs from the track during its movement on said track, the movable part will return to the track. The return control part is configured to limit a force generated by at least one of a plurality of drive devices which drive the robot, to a predetermined upper limit value or less.

### BACKGROUND OF THE INVENTION

1. Field of the Invention

The present invention relates to a robot controller which controls an industrial robot, more particularly relates to a robot controller which comprises a control unit for controlling an operation of a robot so that a movable part which has deviated from a predetermined track will return to the predetermined track.

2. Description of the Related Art

A control device of a vertical articulated robot, horizontal articulated robot, or other industrial robot controls the operation of the robot so that a movable part of the robot (for example, an end effector attached to a front end of an arm) moves on a predetermined track. Further, among control devices of industrial robots, there is one which controls the operation of a robot so that if a movable part of the robot makes an emergency stop as a result of contacting some sort of obstacle, the movable part is returned to a restart position on the original track. Such a control device is illustrated in JP H02-262985A, JP H02-76691A, JP H05-100732A, and JP H08-305429A.

In particular, JP H02-76691A, JP H05-100732A, and JP H08-305429A propose a control device which controls the operation of a robot so that when a movable part of the robot had made an emergency stop, the movable part moves at a low speed to a restart position on the original track. By moving the movable part at a low speed in this way, it is possible to ensure the safety of an operator who works around the robot. However, even if the movable part of the robot moves at a low speed to a restart position, serious injury cannot be avoided in the event of a collision. For example, if the drive torque of the servo motor is relatively large, the movable part of the robot will inflict a large impact force against the object it collides with (for example, an operator or obstacle etc.), and therefore the operator is liable to be injured, or the movable part of the robot or obstacle is liable to be damaged.

A robot controller which can mitigate any injury or damage even if a movable part of a robot which has deviated from its predetermined track collides with an obstacle before returning to its original track has therefore been sought.

### SUMMARY OF INVENTION

According to a first aspect of the present invention, there is provided a robot controller comprising a movement control part which controls an operation of the robot so that a movable part of the robot moves on a predetermined track, and a return control device which controls an operation of the robot so that if a movable part departs from the track during its movement on the track, the movable part will be returned to the track, wherein the return control part limits a force generated by at least one of a plurality of drive devices which drive the robot to a predetermined upper limit value or less.

According to a second aspect of the present invention, there is provided the robot controller according to the first aspect, wherein the return control part sets an end point on the path which the movable part travelled before departing from the track as a destination on the track which the movable part is returned to.

According to a third aspect of the present invention, there is provided the robot controller according to the first aspect, wherein the return control part sets a starting point of the track as a destination on the track which the movable part is returned to.

According to a fourth aspect of the present invention, there is provided the robot controller according to the first or second aspect, wherein the return control part has a command limiting part which limits a command value of force for the at least one drive device within a predetermined range.

According to a fifth aspect of the present invention, there is provided the robot controller according to the first or second aspect, wherein the return control part has a stop control part which detects or estimates a load which is applied to the at least one drive device and which stops operation of the robot if the detected or estimated load exceeds a predetermined threshold value.

According to a sixth aspect of the present invention, there is provided the robot controller according to any one of the first to fourth aspects, wherein the return control part sets as a loop gain of position loop and/or speed loop for feedback control of the at least one drive device a smaller value which than a value set by the movement control part.

These and other objects, features, and advantages of the present invention will become clearer with reference to the detailed description of an illustrative embodiment of the present invention which is shown in the attached drawings.

### BRIEF DESCRIPTION OF THE DRAWINGS

FIG. 1 is a block diagram which shows the configuration of a robot system which includes a robot controller of one embodiment of the present invention.

FIG. 2 is a functional block diagram of one digital servo circuit in FIG. 1.

FIG. 3 is a block diagram which conceptually shows the functions which are exhibited by component elements of the robot controller in FIG. 1 cooperating with one another.

FIG. 4 is a schematic view which shows a program which is used for a movement operation of a robot in FIG. 3.

FIG. 5 is a schematic view for explaining a movement operation of a robot in FIG. 3.

FIG. 6 is a schematic view similar to FIG. 5 for explaining a case where there is an obstacle on the track of a movable part of a robot.

FIG. 7 is a schematic view similar to FIG. 5 and FIG. 6 for explaining the procedure for eliminating a situation which caused a movable part of a robot to stop.

FIG. 8 is a schematic view for explaining a return operation of a robot in FIG. 3.

FIG. 9 is a schematic view similar to FIG. 8 for explaining a modification of a return operation of a robot.

FIG. 10 is a schematic view which shows a setting screen for a return operation which is provided by the robot system of FIG. 1.

FIG. 11 is a flowchart which shows the routine by which a robot controller of the present embodiment runs a program for a movement operation.

### DETAILED DESCRIPTION OF EMBODIMENTS

Below, an embodiment of the present invention will be explained in detail with reference to the drawings. In the drawings, similar component elements are assigned similar reference notations. Note that the following explanation does not limit the technical scope of the inventions which are described in the claims or the meaning of terms etc.

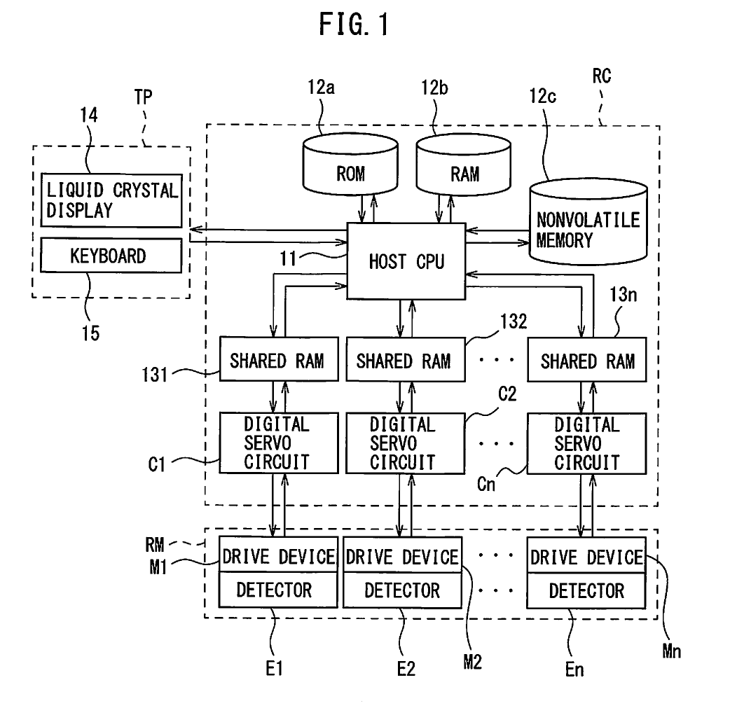

Referring to FIG. 1 to FIG. 11, a robot controller of one embodiment of the present invention will be explained. FIG. 1 is a block diagram which shows the configuration of a robot system which includes an illustrative robot controller RC of the present embodiment. As shown in FIG. 1, the robot controller RC of the present example is respectively connected to a teaching panel TP and robot mechanism RM. First, the robot mechanism RM in FIG. 1 will be explained. As shown in FIG. 1, the robot mechanism RM of the present example includes a plurality of drive devices M1-Mn which generate drive forces of the robot, and a plurality of detectors E1-En which detect positions of movable elements of the drive devices M1-Mn. More specifically, the robot of the present example is a typical vertical articulated robot which has a plurality of joints. Further, the drive devices M1-Mn of the present example are rotary motors which drive the plurality of joints. The detection devices E1-En of the present example are rotary encoders which detect positions of shafts of the drive devices M1-Mn. In this way, the robot mechanism RM has equal numbers of drive devices M1-Mn and detectors E1-En as the number of axes of the robot. The number of axes of the robot is for example six.

Next, the robot controller RC in FIG. 1 will be explained. As shown in FIG. 1, the robot controller RC of the present example includes a host CPU 11 which controls operation of the controller as a whole. Further, the robot controller RC of the present example includes a ROM 12a which stores various system programs, a RAM 12b which is used by the host CPU 11 for temporarily storing various data, and a nonvolatile memory 12c which stores various programs relating to the content of operation of the robot R and related settings etc. As shown in FIG. 1, the host CPU 11 is connected to a plurality of shared RAMs 131-13n. The plurality of shared RAMs 131-13n are connected to a plurality of digital servo circuits C1-Cn. The plurality of shared RAMs 131-13n perform the roles of transmitting movement commands or control signals which are output from the host CPU 11 to the processors of the digital servo circuits C1-Cn and perform the roles of transferring the signals from the processors of the digital servo circuits C1-Cn to the host CPU 11. Therefore, while not shown in FIG. 1, each of the plurality of digital servo circuits C1-Cn contains a processor, ROM, RAM, etc. As shown in FIG. 1, the numbers of the shared RAMS 131-13n and digital servo circuits C1-Cn are equal to the number of axes of the robot.

Next, the teaching panel TP in FIG. 1 will be explained. As shown in FIG. 1, the teaching panel TP of the present example has a liquid crystal display 14 which displays various information to the operator, and a keyboard 15 which receives various commands from the operator. The teaching panel TP of the present example is used by the operator for inputting and changing data in the above-mentioned program and for inputting and changing related settings. Furthermore, the teaching panel TP of the present example is also used by the operator for directly commanding operations to the robot, that is, commanding operations by manual feed operations.

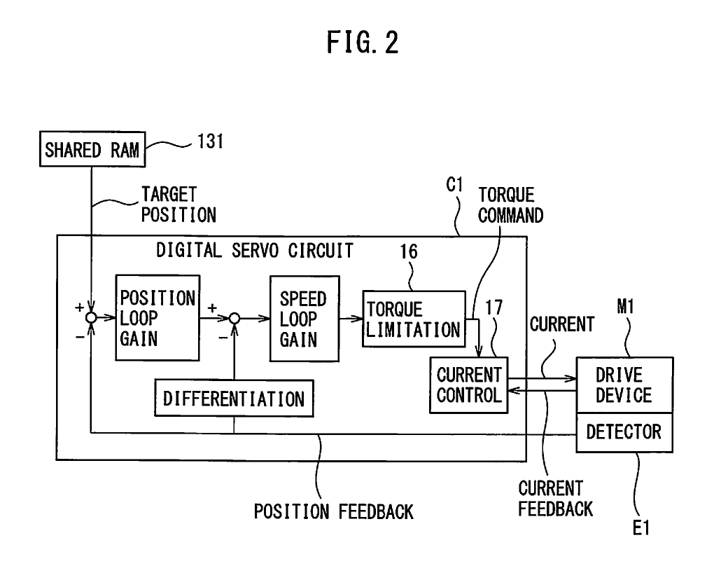

Next, the functions of the plurality of digital servo circuits C1-Cn in FIG. 1 will be explained. These digital servo circuits C1-Cn have similar functions, and therefore below only the functions of one digital servo circuit C1 will be explained. FIG. 2 is a functional block diagram of one digital servo circuit C1 in FIG. 1. As shown in FIG. 2, the digital servo circuit C1 of the present example, first, multiplies a position loop gain with error between a target position and position feedback so as to generate a speed command, next, multiplies a speed loop gain with error between the speed command and a differential of the position feedback so as to generate a torque command. The thus generated torque command is transmitted to a torque limiting block 16.

Further, the torque limiting block 16 performs torque limiting processing for a generated torque command. For example, the torque limiting block 16 performs processing for clamping a torque command so as to protect the drive device M1 when the maximum current value which can be supplied from the robot controller RC to the motor M1 is larger than an allowable current value of the drive device M1. The “allowable current value” of the drive device M1 which is referred to here is the maximum current value which the motor M1 can withstand. In the above processing, the torque command is clamped at a value which corresponds to the allowable current value of the drive device M1. Further, the torque limiting block 16 can also perform processing for clamping a torque command by any upper limit value or lower limit value, and processing for clamping a torque command by any upper limit value and lower limit value. The torque command after torque limiting processing is transmitted to a current control block 17 so as to be converted to an electrical current. As a result, an electrical current which corresponds to the torque command after the toque limiting processing is supplied to the drive device M1, and therefore the drive device M1 generates a drive torque in accordance with the torque command after the torque limiting processing.

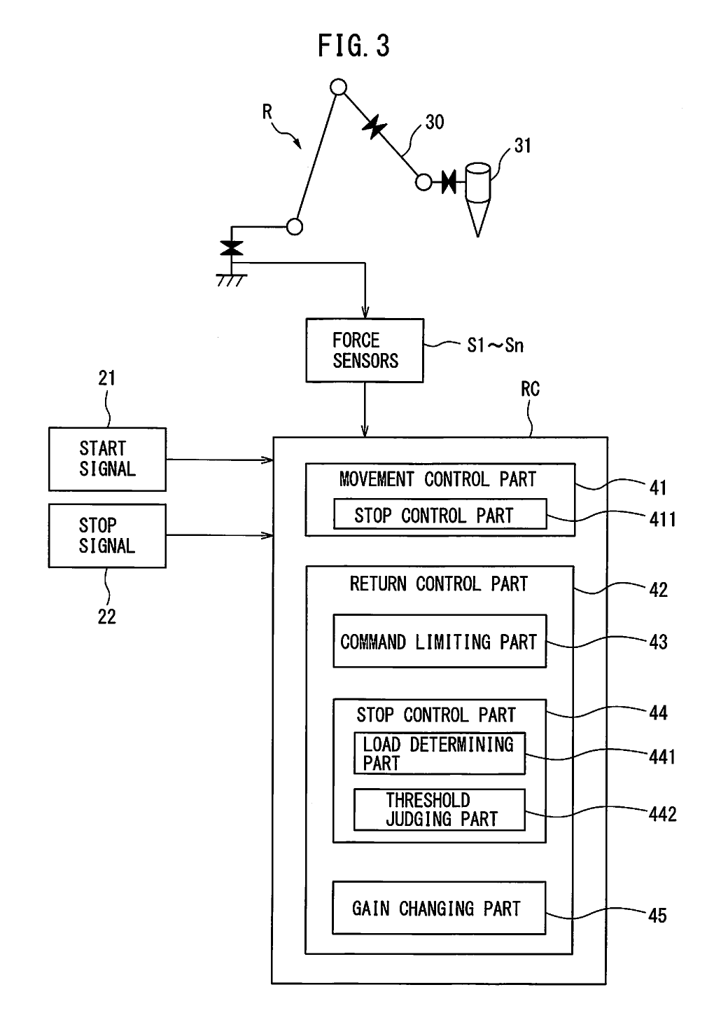

Next, the functions which are exhibited by the above-mentioned component elements of the robot controller RC cooperating with one another will be explained. FIG. 3 is a block diagram which conceptually shows the functions which are exhibited by the component elements of the robot controller RC in FIG. 1 cooperating with one another. For convenience, in FIG. 3, a schematic view of the robot R which has the robot mechanism RM is shown together with a block diagram of the robot controller RC. As shown in FIG. 3, the robot R of the present example comprises an arm 30 which has a plurality of joints, and a movable part 31 which is attached to a predetermined location of the arm 30. More specifically, the movable part 31 of the present example is an end effector which is attached to the front end of the arm 30. Further, in the robot R of the present example, a plurality of force sensors S1-Sn are applied to the shafts of the drive devices M1-Mn so as to detect the loads which are applied to the shafts. More specifically, the force sensors S1-Sn of the present example are torque sensors which detect the load torques which are applied to the shafts of the drive devices M1-Mn of the robot R, that is, the load torques which are applied to the joints of the robot R. The loads detected by the force sensors S1-Sn of the present example are transmitted to the later explained movement control part 41 and return control part 42.

Referring to FIG. 3, in the robot controller RC of the present example, the host CPU 11 and digital servo circuits C1-Cn and other component elements cooperate with one another to exhibit the functions of the movement control part 41 and return control part 42. These functions will be explained in order below. First, the movement control part 41 of the present example controls the operation of the robot so that the movable part 31 of the robot R moves on a predetermined track in accordance with a program in the ROM 12a or nonvolatile memory 12c. An operation of the robot R controlled by the movement control part 41 will hereinafter be referred to as a “movement operation”.

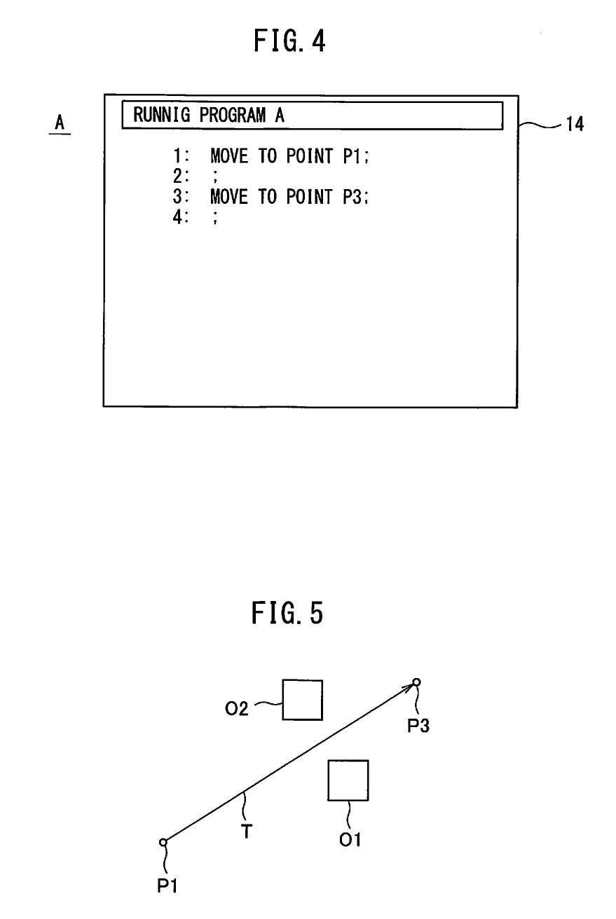

FIG. 4 is a schematic view which shows a program A which is used for a movement operation of the robot R in FIG. 3. FIG. 4 shows the state where a representative program A is displayed on the liquid display 14 of the teaching panel TP. As shown in FIG. 4, the program A of the present example includes commands for moving the movable part 31 of the robot R toward predetermined positions (point P1 and point P3). In order to start this program A, the operator uses the keyboard 15 of the teaching panel TP to input a predetermined start signal 21 to the robot controller RC. Referring again to FIG. 3, the movement control part 41 of the present example includes a stop control part 411. The stop control part 411 of the present example has the function of causing an emergency stop of the robot if load detected by any force sensor S1-Sn exceeds a predetermined threshold value.

FIG. 5 is a schematic view for explaining a movement operation of the robot R in FIG. 3. As shown in FIG. 5, a movement operation of the present example is an operation for moving the movable part 31 of the robot R from the points P1 to P3 on the track T. This means that the point P1 is the starting point of the track T, and the point P3 is the end point of the track T. In the movement operation of the present example, first, the movement control part 41 of the robot controller RC issues a command “move to point P1” of the first line of the program A (see FIG. 4). As a result, the movable part 31 of the robot R moves from the current position toward the point P1. Next, the movement control part 41 of the robot controller RC issues a command “move to point P3” of the third line of the program A (see FIG. 4). As a result, the movable part 31 of the robot R moves from the point P1 toward the point P3 on the track T. In the example of FIG. 5, two objects O1 and O2 are placed near the track T, but these objects O1 and O2 do not block the track T. Since there is no obstacle present on the track T of the movable part 31, the moving part 31 can travel along the track T and reach the point P3.

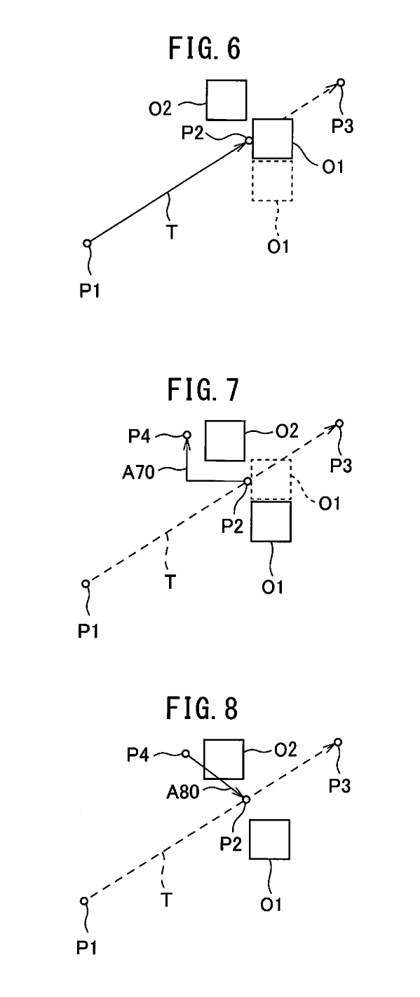

The case where there is some sort of obstacle on the track T of the moving part 31 will be explained. FIG. 6 is a schematic view similar to FIG. 5 for explaining the situation where there is an obstacle on the track T of the movable part 31. In the example of FIG. 6, the object O1 in FIG. 5 has been moved to block the track T. For this reason, the movable part 31 on the track T contacts the object O1 before reaching the point P3, and thus receives a reaction force from the object O1. At that time, if detected load by any force sensor S1-Sn exceeds a predetermined threshold value (x1), the stop control part 411 of the movement control part 41 stops the operation of the robot R. This threshold value (x1) will hereinafter be called a “movement operation threshold value”. Alternatively, an operator who noticed contact of the movable part 31 and the object O1 may input a predetermined stop signal 22 to the robot controller RC so as to stop the operation of the robot R. This stop signal 22, like the above start signal 21, is input via the keyboard 15 of the teaching panel TP (see FIG. 1 and FIG. 3). The position of the movable part 31 which has been stopped due to the above stop signal 22 is shown by the point P2 in FIG. 6.

If the movable part 31 is stopped in the middle of a movement operation in this way, it is necessary to eliminate the situation which caused the movable part 31 to be stopped, before restarting the movement operation of the robot R. FIG. 7 is a schematic view similar to FIG. 5 and FIG. 6 for explaining the procedure for eliminating the situation which caused the movable part 31 of the robot R to be stopped. In the example of FIG. 7, first, the operator makes the movable part 31 depart from the track T in accordance with a manual feed operation of the robot R using the teaching panel TP. As a result, the movable part 31 retracts from the point P2 on the track T to a point P4 at the outside of the track T. The path through which the movable part 31 retracts from the point P2 to the point P4 is expressed by the arrow A70 in FIG. 7. Next, the operator moves the object O1 which caused the movable part 31 to be stopped. This ensures that the object O1 is removed from the track T of the movable part 31. In accordance with this procedure, the preparations are finished for restarting the movement operation of the robot R. When the above procedure is finished, the return control part 42 of the robot controller RC returns the movable part 31 of the robot R to the track T. In the example of FIG. 7, the movable part 31 departs from the track T due to a manual feed operation of the operator, but the moving part 31 may depart from the track T due to inertial motion after contact with an obstacle.

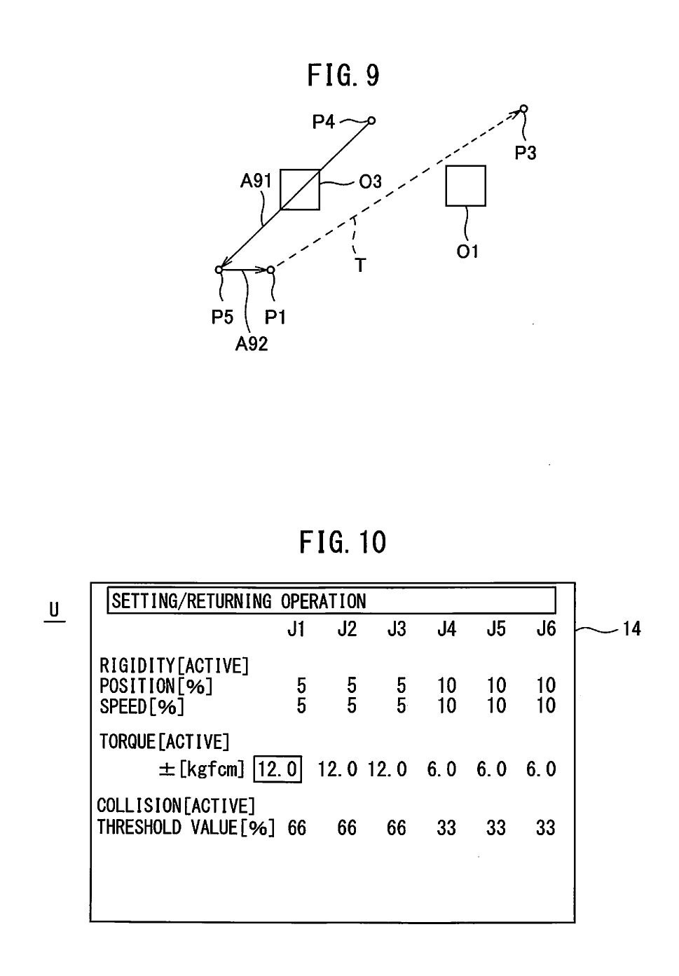

Referring again to FIG. 3, the return control part 42 of the present example will be explained. The return control part 42 of the present example controls the operation of the robot R so that the movable part 31 is returned to the track T if the movable part 31 departs from the track T before reaching the end point P3. The operation of the robot R which is controlled according to the return control part 42 will hereinafter be referred to as a “return operation”. FIG. 8 is a schematic view for explaining a return operation of the robot 3 in FIG. 3. As explained above, the movable part 31 of the robot R has deviated from the point P2 on the track T and retracted to the point P4 due to a manual feed operation of the operator or inertial motion before the return operation of the robot R is started. As shown by the arrow A80 in FIG. 8, a return operation of the present example is an operation for moving the movable part 31 from the point P4 to the point P2. This means that, in the example of FIG. 8, the end point of the path which the movable part 31 traveled before departing from the track T (i.e. point P2) is set as the destination of the return operation. More specifically, in the return operation of the present example, the return control part 42 of the robot controller RC issues a command for movement to the point P2. Further, when the movable part 31 reaches the point P2 according to this command (that is, when the return operation is finished), the movement control part 41 of the robot controller RC again issues a command “move to point P3” which corresponds to line 3 of the program A (see FIG. 4). The movement operation of the robot R is thus restarted. FIG. 9 shows a modification of the restart operation of the robot R. This modification will be explained later.

As will be understood from comparison between FIG. 7 and FIG. 8, the path of movement of the movable part 31 resulting from the restart operation does not always match the path of movement of the movable part 31 resulting from a manual feed operation of the operator or inertial motion (see arrows A70 and A80 in figure). Accordingly, when the path of movement resulting from the return operation is blocked by the object O2 as shown in FIG. 8, the movable part 31 contacts the object O2 before reaching the destination (P2). In this connection, a large force is applied from the movable part 31 to the object O2 for the reasons explained below, and therefore the object O2 and the movable part 31 are considerably damaged even if the prior art described in JP H02-76691A, JP H05-100732A, and JP H08-305429A are used to move the movable part 31 at a low speed. While the movable part 31 is contacting the object O2, the joints of the robot R cannot be rotated, and therefore position feedback from the detectors E1-En to the digital servo circuits C1-Cn remains constant. Accordingly, while the movable part 31 is contacting the object O2, the speed feedback which is the differential of the position feedback remains zero. However, a command for movement to the point P2 continues to be issued during that period, and therefore the error between the target position and position feedback of the drive devices M1-Mn continues to be increased. Further, while the speed feedback is zero, the torque command is obtained by multiplying the above error with the position loop gain and speed loop gain (see FIG. 2), and therefore the drive torques of the drive devices M1-Mn are increased as the above error is increased. In this way, while the movable part 31 is contacting the object O2, the drive torques of the drive devices M1-Mn continue to be increased, and therefore the force acting from the movable part 31 to the object O2 also continues to be increased.

In order to mitigate the damage to the object O2 and movable part 31 which may occur for the above reason, the return control part 42 of the present example has the function of limiting the force generated by at least one of the plurality of drive devices M1-Mn (that is, the drive torque) to a predetermined upper limit value or less. More specifically, the return control part 42 of the present example is provided with a torque limiting unit for limiting the drive torques generated by the drive devices M1-Mn to a predetermined upper limit value or less, and the torque limiting unit is constituted by a command limiting part 43 and stop control part 44 (see FIG. 3). These functions will be explained below in detail. First, the command limiting part 43 of the present example has the function of limiting the command values of the forces which are generated by the plurality of drive devices M1-Mn within a predetermined range. More specifically, the command limiting part 43 of the present example has the function of limiting the torque commands for the plurality of drive devices M1-Mn to within a predetermined range. This function is, for example, realized by the torque limiting blocks 16 in the digital servo circuits C1-Cn which clamp the torque commands at predetermined upper limit value and lower limit value. The upper limit value and the lower limit value for the clamping of the torque commands are designated by the operator on a previously prepared setting screen for the return operation, for example.

FIG. 10 is a schematic view which shows a setting screen U for the return operation, which is provided by the robot system of FIG. 1. This setting screen U is displayed on the liquid crystal display 14 of the teaching panel TP, for example. In the setting screen U of the present example, the operator can designate the tolerance from the drive torque at the time of start of the return operation in units of kgfcm by entering a desired value in the “torque” row. As shown in FIG. 10, it is possible to input a desired value for each of the joints J1-J6 in the “torque” row of the setting screen U of the present example. Note that, the drive torque at the time of start of the return operation corresponds to the drive torque which is required for supporting the robot mechanism RM against gravity. The values which are input by the operator at the “torque” row of the setting screen U are stored in the nonvolatile memory 12c, and then are set on the torque limiting blocks 16 of the digital servo circuits C1-Cn by the host CPU 11 through the shared RAMs 131-13n in. This ensures that the torque commands generated by the digital servo circuits C1-Cn are limited to the range from “drive torque at start of return operation minus input value” to “drive torque at start of return operation plus input value”, and therefore the drive torques generated by the drive devices M1-Mn are limited to the predetermined upper limit values or less. The upper limit value of the drive torque in this example is the “drive torque at start of return operation plus input value”.

Next, the stop control part 44 of the present example has the function of immediately stopping the return operation of the robot R if load applied to any of the drive devices M1-Mn exceeds a predetermined threshold value. As shown in FIG. 3, the stop control part 44 of the present example includes a load determining part 441 and a threshold value judging part 442. The load determining part 441 of the present example uses the above force sensors S1-Sn to detect the loads applied to the drive devices M1-Mn. However, the load determining part 441 may also use various known methods to estimate the loads applied to the drive devices M1-Mn. The threshold value judging part 442 of the present example judges whether the load detected or estimated by the load determining part 441 exceeds a predetermined threshold value. Further, the stop control part 44 of the present example immediately stops the return operation of the robot R if the load detected or estimated by the load determining part 441 exceeds a predetermined threshold value. The threshold value used for the judgment of the threshold value judging part 442 is designated by the operator on the above setting screen U, for example. Below, in order to distinguish between the threshold value (x2) for judgment of the threshold value judgment part 442 and the movement operation threshold value (x1), the former threshold value (x2) will be called the “return operation threshold value (x2)”.

With reference to FIG. 10, in the setting screen U of the present example, the operator can designate the ratio (x2/x1) of the return operation threshold value (x2) with respect to the movement operation threshold value (x1) by a percentage, by entering a desired value in the “collision” row. The movement operation threshold value (x1) is stored in advance in the ROM 12a or nonvolatile memory 12c etc. As shown in FIG. 10, it is possible to enter a desired value for each of the joints J1-J6 in the “collision” row of the setting screen U of the present example. If the load applied to any of the joints J1-J6 exceeds the return operation threshold value (x2), the return operation of the robot R is immediately stopped, and consequently the drive torques generated by the drive devices M1-Mn are limited to predetermined upper limit values or less. The upper limit value of the drive torque in this example is the return operation threshold value (x2).

With reference to FIG. 3, the return control part 42 of the present example further includes a gain changing part 45. The gain changing part 45 of the present example has the function of changing the loop gain which is used for feedback control of the drive devices M1-Mn, that is, the loop gain which is set on the digital servo circuits C1-Cn. In particular, the gain changing part 45 of the present example sets as the loop gain for the return operation of the robot R, a smaller value than the loop gain for the movement operation of the robot R. This function is realized by the host CPU 11 which sets the return operation loop gain stored in the nonvolatile memory 12c, on the digital servo circuits C1-Cn through the shared RAMs 131-13n, for example. The return operation loop gain is designated on the above setting screen U by the operator, for example. The movement operation loop gain is stored in advance in the ROM 12a or nonvolatile memory 12c etc.

With reference to FIG. 10, in the setting screen U of the present example, the operator can designate the ratio of the position loop gain for the return operation with respect to the position loop gain for the movement operation by a percentage, by entering a desired value in the “position” row of the “rigidity” column. Similarly, in the setting screen of the present example, the operator can designate the ratio of the speed loop gain for the return operation with respect to the speed loop gain for the movement operation by a percentage, by entering a desired value in the “speed” row of the “rigidity” column. As shown in FIG. 10, at the rows of “position” and “speed” of the setting screen U of the present example, it is possible to enter a desired value smaller than 100% for each of the joints J1-J6. The position loop gain and speed loop gain for the return operation are thus smaller than the position loop gain and speed loop gain for the movement operation. As will be understood from FIG. 2, the torque commands generated by the digital servo circuits C1-Cn are proportional to the position loop gain and the speed loop gain. Accordingly, as the position loop gain and the speed loop gain become smaller, the torque commands generated by the digital servo circuits C1-Cn become smaller as well and the drive torques generated by the drive devices M1-Mn are thus decreased.

Next, a modification of the return operation of the robot R will be explained. FIG. 9 is a schematic view similar to FIG. 8 for explaining a modification of the return operation of the robot R in FIG. 3. In the same way as the example of FIG. 8, the movable part 31 of the robot R has deviated from the track T and retracted to the point P4 due to a manual feed operation of the operator or inertial motion before the return operation of the robot R is started. As shown by the arrows A91 and A92 in FIG. 9, the return operation of the present example is an operation for moving the movable part 31 from the point P4 to the point P1 via the point P5. This means that in the example of FIG. 9, the starting point P1 of the track T is set as the destination of the return operation and a point P5 located outside the track T is set as a relay point. The above relay point P5 is designated in advance by the operator.

In the same way as the example of FIG. 8, in the return operation of the present example, the path of movement of the movable part 31 resulting from the restart operation does not match the path of movement of the movable part 31 resulting from a manual feed operation or inertial motion. Accordingly, when the path of movement of the movable part 31 which is shown by the arrow A91 is blocked by the object O3 as shown in FIG. 9, the movable part 31 contacts the object O3 before reaching the relay point P5. However, the drive torques of the drive devices M1-Mn will be limited to predetermined upper limit values or less by means of the return control part 42 while the moving part 31 moves on the path of the arrow A91, and therefore it is possible to mitigate damage to the movable part 31 and object O3 due to contact between them. The destination of the movable part 31 in the return operation of the robot R is not limited to the example of FIG. 8 and FIG. 9, and any point on the track T can be set as the destination of the movable part 31.

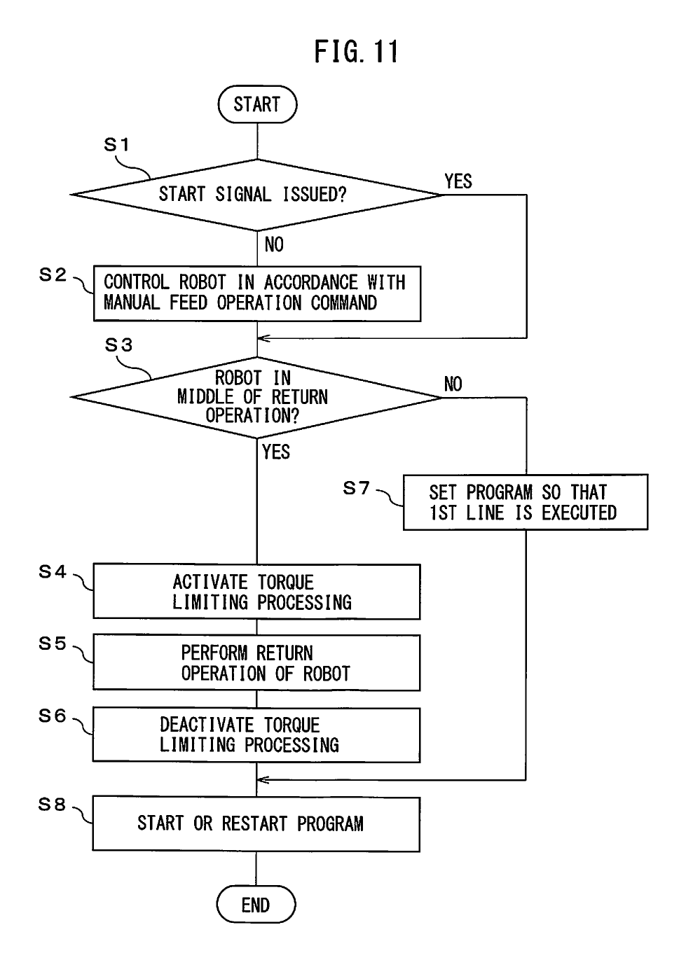

Next, an outline of the operation of a robot system including the robot controller RC of the present embodiment will be explained. FIG. 11 is a flowchart which shows the routine for the robot controller RC of the present embodiment to run the program A for movement operation use. As shown in FIG. 11, at step S1, the robot controller RC judges if the above start signal 21 has been issued. As explained above, the start signal 21 is transmitted from the teaching panel TP to the robot controller RC, for example. When a start signal 21 has been issued (YES at step S1), the robot controller RC further judges if the robot R is in the middle of a return operation (step S3). On the other hand, when the start signal 21 is not issued (NO at step S1), the robot controller RC controls the operation of the robot R in accordance with the command for manual feed operation (step S2) and then performs the judgment of step S3 when the command for manual feed operation is completed. As explained above, the operational command for manual feed operation of the robot R is received from the operator through the teaching panel TP.

IF it is judged at step S3 that the robot R is in the middle of a return operation (YES at step S3), the robot controller RC proceeds to the later explained step S4. The robot R being in the middle of a return operation means that the movable part 31 of the robot R has contacted an obstacle to make an emergency stop during a movement operation, and thus deviated from the track T due to a manual feed operation or inertial motion (see FIG. 7). On the other hand, if it is judged at step S3 that the robot R is not in the middle of a return operation (NO at step S3), the robot controller RC sets the program A so that its first line is executed (step S7). As a result, at step S8, the program A is started from the first line (see FIG. 4). In this way, the robot controller RC of the present example monitors the presence of a start signal 21 from the teaching panel TP etc. (step S1), and starts the program A from the first line if it receives a start signal 21 during time when the return operation of the robot R is not in progress (step S8).

With reference to FIG. 11, at step S4, the robot controller RC activates the torque limiting processing. The “torque limiting processing” referred to here is processing for limiting the drive torques of the drive devices M1-Mn to upper limit values or less in accordance with the settings which are selected on the setting screen U of FIG. 10. Next, at step S5, the robot controller RC performs a return operation of the robot R according to the procedure which is shown in FIG. 8 or FIG. 9. The movable part 31 of the robot R is thus moved from the above-mentioned position after retraction (for example, the point P4 in FIG. 8) toward the target position of the return operation (for example, the point P2 in FIG. 8). At this step, the movable part 31 may head toward the target position via an arbitrary relay point (see FIG. 9). Even if the movable part 31 contacts an obstacle during the return operation of step S5, the movable part 31 and obstacle do not receive major damage since the torque limiting processing was activated at step S4. Next, at step S6, the robot controller RC deactivates the torque limiting processing. Next, at step S8, the robot controller RC restarts the program A. More specifically, when step S8 is performed after step S6, the program A is restarted from the line which was in progress at the time of emergency stop of the robot R.

As explained above, in the robot controller RC of the present embodiment, the drive torques of the drive devices M1-Mn are limited to predetermined upper limit values or more by the return control part 42 which controls the return operation of the robot R. Accordingly, according to the robot controller RC of the present embodiment, even if a movable part 31 contacts an obstacle while returning to a destination on the track T, it is possible to mitigate the damage received by the movable part 31 and obstructing part. Such an effect is achieved not only when the end point P2 of the path which the movable part 31 travelled before departing from the track T is set as the destination of the track T, but also when the starting point P1 is set as the destination on the track T.

Further, in the robot controller RC of the present embodiment, for example, the command limiting part 43 of the return control part 42 limits the drive torques of the drive devices M1-Mn to predetermined upper limit values or less, by clamping the torque commands to the drive devices M1-Mn, for example. Therefore, according to the robot controller RC of the present embodiment, it is possible to mitigate damage to the movable part 31 and obstacle due to contact between them, without using complicated peripheral equipment etc. Further, in the robot controller RC of the present embodiment, the stop control part 44 of the return control part 42 limits the drive torques of the drive devices M1-Mn to a predetermined upper limit value or less by stopping the return operation of the robot R once the load of any drive device M1-Mn exceeds a predetermined threshold value (x2). Therefore, according to the robot controller RC of the present embodiment, it is possible to mitigate damage to the movable part 31 and obstacle due to contact between them and thus possible to prevent subsequent worsening of the damage to the movable part 31 and obstacle.

Furthermore, in the robot controller RC of the present embodiment, the gain changing part 45 of the return control part 42 changes the values of the loop gains which are set on the digital servo circuits C1-Cn, so that the values of the position loop gain and/or speed loop gain for the return operation of the robot R are smaller than the values for movement operation of the robot R. Therefore, according to the robot controller RC of the present embodiment, the command values of the drive torques for the drive devices M1-Mn are relatively small during a return operation of the robot R, and therefore it is possible to mitigate damage to the movable part 31 and obstacle due to contact between them.

### EFFECT OF INVENTION

According to the first to third aspects of the present invention, until a movable part of a robot which has deviated from a predetermined track is returned to the original track, the force generated by a drive device of the robot is limited to a predetermined upper limit value or less. Therefore, according to the first to third aspects, even if the movable part contacts an obstacle while returning to the original track, it is possible to mitigate the damage received by the movable part and obstructing part due to contact between them. In particular, according to the second aspect, when the end point of the path which the movable part traveled before departing from the track is designated as the destination of the movement operation, it is possible to mitigate the damage to the movable part and obstacle due to contact between them. In particular, according to the third aspect, when the starting point of the track is designated as the destination of the return operation, it is possible to mitigate damage to the movable part and obstacle due to contact between them.

According to the fourth aspect of the present invention, the command value of the force for a drive device of the robot is limited to a predetermined range, and consequently the force generated by the drive device is limited to a predetermined upper limit value or less. This can be achieved by clamping the torque command for the drive device, for example. Therefore, according to the fourth aspect, even without using complicated peripheral equipment etc., it is possible to mitigate damage to the movable part and obstacle due to contact between them.

According to the fifth aspect of the present invention, the robot is stopped once a load on a drive device of the robot exceeds a predetermined threshold value, and therefore it is possible to mitigate damage to the movable part and obstacle due to contact between them and thus possible to prevent subsequent worsening of the damage to the movable part and obstacle.

According to the sixth aspect of the present invention, the position loop gain and/or speed loop gain which are used for the return operation are smaller than the values which are used during normal movement operations. Therefore, according to the sixth aspect, the command value of the force for a drive device of the robot is relatively small while a return operation is in progress, and therefore it is possible to further mitigate damage to the movable part and obstacle due to contact between them.

The present invention is not limited to the above-mentioned embodiment and can also be modified in various ways within the scope described in the claims. For example, a robot R constituted by a vertical articulated robot was illustrated in the above embodiment, but the robot R controlled by the robot controller RC of the present invention may be any robot which can move an end effector or other movable part 31 on a predetermined track T. For example, the robot R controlled by the robot controller RC may also be a horizontal articulated robot or orthogonal robot etc. Further, the drive devices M1-Mn which drive the robot R need not be the rotary motors which were illustrated in the above embodiment, and may also be linear motors with movable elements which can make linear movements. In such a case, the return control part 42 of the robot controller RC limits the drive forces of the drive devices M1-Mn to predetermined upper limit values or less, instead of the drive torques of the drive devices M1-Mn. Further, the functions and structures of the devices in the robot system which are described in the above embodiment are only examples. Various functions and structures etc. can be employed for achieving the effects of the present invention.

1. A robot controller comprising
a movement control part which controls an operation of a robot so that a movable part of said robot moves on a predetermined track, and
a return control device which controls an operation of said robot so that if the movable part departs from said track during its movement on said track, said movable part will return to said track, wherein
said return control part limits a force generated by at least one of a plurality of drive devices which drive said robot to a predetermined upper limit value or less.

2. The robot controller according to claim 1, wherein
said return control part sets an end point on the path which said movable part has traveled before departing from said track as a destination on said track which said movable part is returned to.

3. The robot controller according to claim 1, wherein
said return control part sets a starting point of said track as a destination on said track which said movable part is returned to.

4. The robot controller according to claim 1, wherein
said return control part has a command limiting part which limits a command value of force for said at least one drive device within a predetermined range.

5. The robot controller according to claim 1, wherein
said return control part has a stop control part which detects or estimates a load which is applied to said at least one drive device and which stops operation of said robot if the detected or estimated load exceeds a predetermined threshold value.

6. The robot controller according to claim 1, wherein
said return control part sets as a loop gain of position loop and/or speed loop for feedback control of said at least one drive device a smaller value than a value set by said movement control part.
